(19) United States
(12) Patent Application Publication
(10) Pub. No.: US 2006/0253319 A1
(43) Pub. Date: Nov. 9, 2006

(54) Mechanism for allocating advertisements of varying intervals

(75) Inventors: Jennifer T. Chayes, Seattle, WA (US); Christian H. Borgs, Seattle, WA (US); Uriel M. Feige, Bellevue, WA (US); Nicole S. Immorlica, Mont Vernon, NH (US); Mohammad Mahdian, Bellevue, WA (US); Amin Saberi, Palo Alto, CA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/122,281

(22) Filed: May 4, 2005

(51) Int. Cl. G06Q 30/00

(52) U.S. Cl. 705/14

(57) ABSTRACT

The subject invention leverages determined values of auction advertisement proposals to facilitate in determining advertisement interval allocations for the proposals. The advertisement “interval” can include, but is not limited to, physical dimensions or time. Instances of the subject invention further utilize allocation algorithms and auctioning mechanisms to provide for allocation of ads of varying intervals and to improve performance of ad auctions, including employing algorithms that automate the ad interval layout to maximize revenue. Other instances of the subject invention provide pricing for the allocated intervals as well.

### TECHNICAL FIELD

The subject invention relates generally to advertisement auctions, and more particularly to systems and methods for allocating advertisements of varying intervals in advertisement auctions.

### BACKGROUND OF THE INVENTION

Advertising in general is a key revenue source in just about any commercial market. To reach as many consumers as possible, advertisements or “ads” are typically presented via billboards, television, radio, and print media such as newspapers and magazines. However, with the advent and rise of the Internet, advertisers have found a new and perhaps less expensive medium for reaching vast numbers of potential customers across a large and diverse geographic span. Advertisements on the Internet can primarily be seen on web pages or web sites as well as in pop-up windows when a particular site is visited.

Typically, advertising space is not an unlimited resource. Thus, many businesses have resorted to participating in advertisement auctions. These auctions are utilized to sell advertising space based on “utility” to a bidder and/or based upon maximizing revenue to a seller. Utility or “value” to the bidder is not necessarily based on how much a bidder can afford to pay. A bidder may value the advertising space substantially but might not be able to afford to offer very much in monetary terms. Thus, a seller desiring to maximize revenue may sell to a bidder that has more monetary means but values the advertising space much less than another bidder. To facilitate in balancing value and revenue maximization, various advertising auction schemes have been devised to promote attempted value maximizing while still generating revenue for the advertising space.

One particular constant in these types of advertising auctions is that the advertising space itself is fixed. In other words, an advertisement seller offers a set advertisement size for auction. For example, an advertising “bar” found at the top of a web page or an advertising side bar on a web page is offered at auction. The advertising space is typically sold to one bidder who then utilizes it to display their advertisement. If a seller wants to sell multiple advertisements, they must know ahead of time what size to make each advertising space. Sellers typically would not allow bidders to advertise in more than one predetermined available space.

Although this provides a simplistic and convenient method of disseminating advertising space, it does not necessarily maximize revenue nor fully empower the advertisers to maximize their advertising potentials. It would prove highly desirable if bidders could compete not only in presenting their advertisements, but also in gaining control of advertising space over their competitors. Likewise, an advertiser might not be able to fully afford to purchase, for example, a full page advertisement, but would still like to be able to participate in an advertisement auction to gain some portion of an important advertising space on a popular web page.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention relates generally to advertisement auctions, and more particularly to systems and methods for allocating advertisements of varying intervals in advertisement auctions. Determined values of auction advertisement proposals are leveraged to facilitate in determining advertisement interval allocations for the proposals. The advertisement “interval” can include, but is not limited to, physical dimensions or time. Thus, instances of the subject invention can be utilized for graphical advertisement allocations, audio advertisement allocations, and/or video/television advertisement allocations and the like. Instances of the subject invention further utilize allocation algorithms and auctioning mechanisms to provide for allocation of ads of varying intervals and to improve performance of ad auctions, including employing algorithms that automate the ad interval layout to maximize revenue. The subject invention allows advertisers to refine their advertising campaigns to more closely align with their goals of higher visibility and lower visibility of the competition, thus leading to higher advertising revenue. Other instances of the subject invention provide pricing for the allocated intervals as well.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of an advertisement allocation system in accordance with an aspect of the subject invention.

FIG. 2 is another block diagram of an advertisement allocation system in accordance with an aspect of the subject invention.

FIG. 3 is yet another block diagram of an advertisement allocation system in accordance with an aspect of the subject invention.

FIG. 4 is a flow diagram of a method of facilitating advertisement allocations in accordance with an aspect of the subject invention.

FIG. 5 is a flow diagram of a method of facilitating advertisement proposal value determinations in accordance with an aspect of the subject invention.

FIG. 6 is a flow diagram of a method of facilitating advertisement allocation pricing in accordance with an aspect of the subject invention.

FIG. 7 illustrates an example operating environment in which the subject invention can function.

FIG. 8 illustrates another example operating environment in which the subject invention can function.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers. A “thread” is the entity within a process that the operating system kernel schedules for execution. As is well known in the art, each thread has an associated “context” which is the volatile data associated with the execution of the thread. A thread's context includes the contents of system registers and the virtual address belonging to the thread's process. Thus, the actual data comprising a thread's context varies as it executes.

Instances of the subject invention provide improved advertisement allocation systems and methods that allow advertising auction bids for advertisements or “ads” of varying intervals. This allows advertisers to refine their advertising campaigns to more closely align with their goals of higher visibility and lower visibility of the competition, thus leading to higher advertising revenue. Instances of the subject invention utilize allocation algorithms and auctioning mechanisms to provide for allocation of ads of varying intervals. This permits allocating and auctioning ads of varying intervals such as, for example, on a web search page that currently only allows advertisement auction bids for ads of a specific pre-defined size. Instances of the subject invention improve performance of ad auctions and can employ algorithms that automate the ad interval layout to maximize revenue.

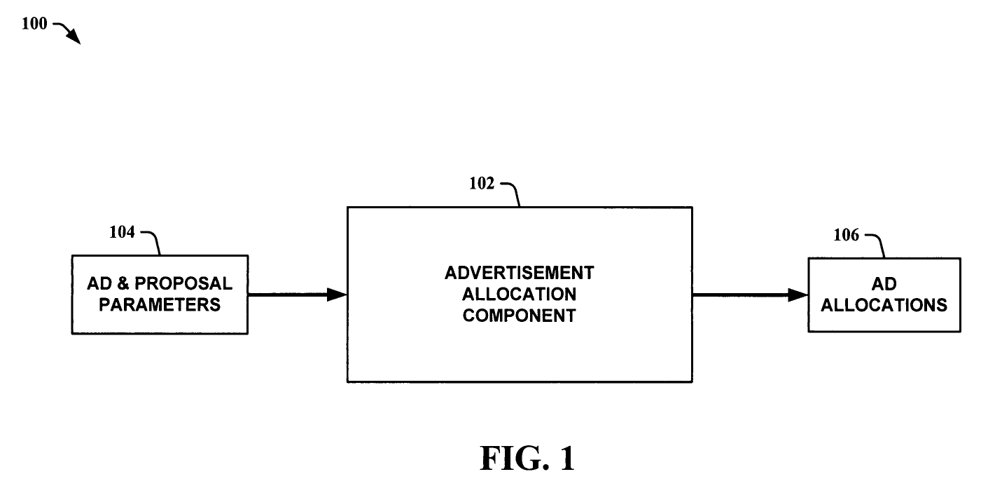

In FIG. 1, a block diagram of an advertisement allocation system 100 in accordance with an aspect of the subject invention is shown. The advertisement allocation system 100 is comprised of an advertisement allocation component 102 that receives ad & proposal parameters 104 and provides ad allocations 106. The advertisement allocation component 102 utilizes the ad & proposal parameters 104 to determine allocations of ads of varying intervals. An interval can include, but is not limited to, a physical dimension such as, for example, as a graphical advertisement can possess or time such as, for example, as a television and/or radio advertisement can possess. Typically, a total ad interval is determined such as, for example, a one column advertisement space on a web page or a number of units of time or physical dimension that are to be included in an advertisement auction. Proposals are accepted that relate to the available total ad interval and are utilized by the advertisement allocation component 102 to facilitate in determining the advertisement allocations. Generally, the proposals facilitate in providing a value (i.e., a value to society or “welfare” value). This value can incorporate a perceived value (i.e., bid or “offer”) that each advertiser appears to place on some unit of the total ad interval in their proposal. Means of determining these “welfare” values include such means as, for example, determining click-through-rates (CTR) and costs-per-click (CPC) for a particular proposal and the like and are described infra. The advertisement allocation component 102 then utilizes the values and an allocation algorithm to determine the advertisement allocations 106.

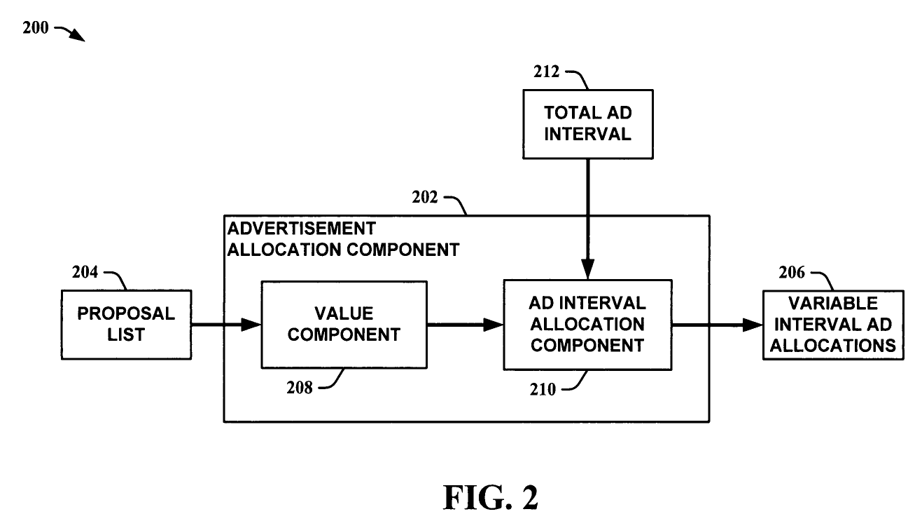

Turning to FIG. 2, another block diagram of an advertisement allocation system 200 in accordance with an aspect of the subject invention is depicted. The advertisement allocation system 200 is comprised of an advertisement allocation component 202 that receives a proposal list 204 and a total ad interval 212 and determines variable interval ad allocations 206. The advertisement allocation component 202 is comprised of a value component 208 and an ad interval allocation component 210. The value component 208 receives the proposal list 204 and utilizes it to facilitate in determining values for each of the proposals in the proposal list 204 (i.e., converting the proposal list into a value list). The proposal list 204 can be comprised of bids and advertisement intervals associated with those bids. The ad interval allocation component 210 then receives the values along with the total ad interval 212. The total ad interval 212 can be comprised of a single unit of a time value such as, for example, a 90-second commercial advertisement spot on a radio station and the like and/or a physical dimension value such as, for example, total length of advertisement space available and the like. The total ad interval 212 can also be comprised of multiple units of time and/or physical dimensions such as units of a standardized advertising interval. The ad interval allocation component 210 generally employs an allocation method that utilizes an allocation algorithm such as, for example, those described in more detail infra. Thus, some instances of the subject invention utilize the value for the allocation process to optimize the overall welfare benefit of the variable interval ad allocations 206.

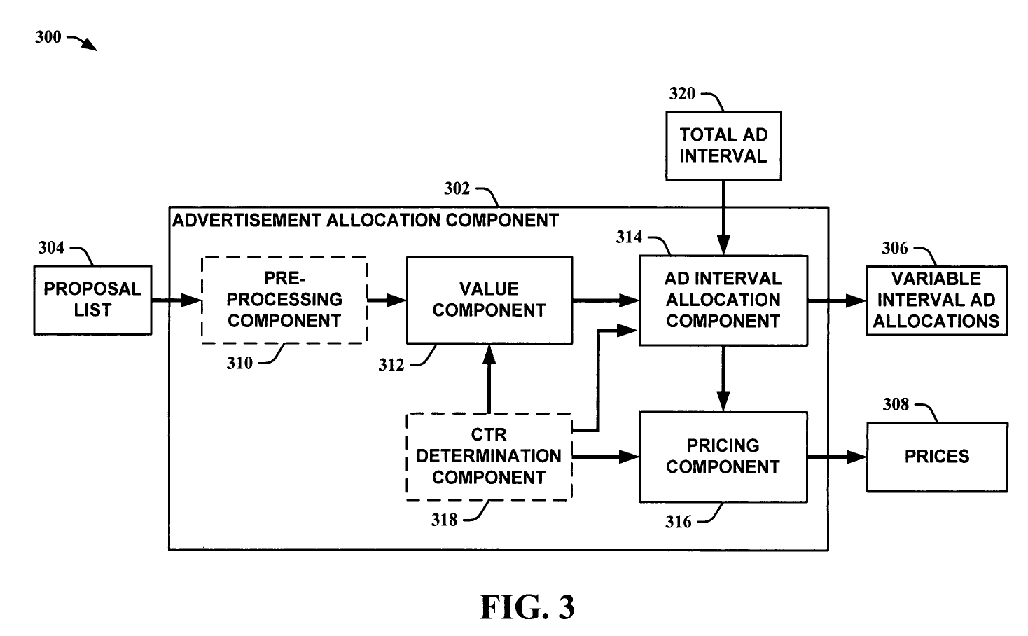

Looking at FIG. 3, yet another block diagram of an advertisement allocation system 300 in accordance with an aspect of the subject invention is illustrated. The allocation system 300 is comprised of an advertisement allocation component 302 that receives a proposal list 304 and a total ad interval 320 and provides variable interval ad allocations 306 and prices 308. The proposal list 304 and the total ad interval 320 can be comprised of content as described supra. The advertisement allocation component 302 is comprised of an optional pre-processing component 310, a value component 312, an ad interval allocation component 314, a pricing component 316, and an optional click-through-rate (CTR) determination component 318.

The optional pre-processing component 310 is utilized to provide initial screening of the proposal list 304 so that advertisements that would not receive an allocation and/or are substantially unlikely to receive an allocation are removed at the initial stages, thus, improving the running time. This pre-processing component 310 is optional because it is not required that these types of proposals be removed in order to determine variable interval ad allocations 306. Thus, the value component 312 can receive the pre-screened proposal list from the pre-processing component 310 and/or directly receive the proposal list 304. The value component 312 then determines values of the proposals from the proposal list 304. The value component 312 can utilize information from the optional CTR determination component 318 to facilitate in the value determinations. The optional CTR determination component 318 determines click-through-rates for advertisements associated with, for example, a web page and the like. The component 318 is optional because not all instances of the subject invention are utilized with advertisements that have “click” associations. A click is essentially an expression of intent, desire, and/or interest expressed by one who experiences an advertisement. Thus, one skilled in the art can appreciate that other components representative of those intents, desires, and/or interests can be substituted for the CTR determination component 318 and still be within the scope of the subject invention.

The ad interval allocation component 314 then receives the values determined by the value component 312 along with the total ad interval 320 that can be comprised of single or multiple interval units and the like. The ad interval allocation component 314 then determines variable interval ad allocations 306 via utilization of the values and an allocation algorithm. In other instances of the subject invention, the optional CTR determination component 318 can provide CTR information that is also utilized by the ad interval allocation component 314 to facilitate in determining variable interval ad allocations 306. The pricing component 316 then receives the allocations from the ad interval allocation component 314 and determines prices 308 for the variable interval ad allocations 306. The pricing component can also utilize CTR information from the optional CTR determination component to facilitate in pricing determination. Pricing means are discussed in more detail infra.

Instances of the subject invention are extremely useful because of the goals of advertising. One such goal is to increase the visibility of the advertiser. This can be accomplished by displaying larger advertisements which tend to be more eye-catching; e.g., a full-page ad in a newspaper is more visible (and more expensive) than a quarter-page ad. Another goal of advertising or business conduct in general, is to decrease the visibility of the competition. For example, in a supermarket, a soda company might stock multiple flavors of soda in order to crowd the shelves with their own products and thus prevent the space from offering other companies' sodas. In a similar fashion, online advertisers would value the opportunity to buy ads that increase their visibility and block the visibility of the competition.

In ad auctions, both of the above goals can be accomplished by allowing advertisers to submit ads that occupy varying intervals. For example, suppose there is an ad interval such as a 10×1 grid of space on a search page allocated to advertisements. An ad auction might allow advertisers to submit bid proposals of the form “I will pay 0.05 per click for an ad of size 5×1.” If such a bid were to win the auction, the advertiser would be guaranteed a large ad and also know that they must share the ad space with at most 5 other competitors.

Instances of the subject invention can be utilized to determine ad “intervals” which include both time and dimension variants. Thus, an interval can be a 30-second television advertisement interval or the interval can be a particular length of an advertisement space on an online web page and/or a printed page. Although the following examples, for brevity, utilize examples with length intervals, one skilled in the art can appreciate that employing other intervals such as, for example, time is within the scope of the subject invention as well.

Value Determination

In the most general setting, each advertiser is assumed to have a set of ads of width “1” and possibly varying lengths. The length of an ad A is denoted by l(A). Thus, there is an “L×1” grid of ad intervals available for allocation to the advertisers. One skilled in the art can appreciate that L represents but one type of interval and that, for example, T representative of time can easily be substituted for in the methods for determining value and fall within the scope of the subject invention. A feasible solution for the value determination is an assignment of a subset S of ads to the ad intervals such that:
each ad of length l in S is assigned to l consecutive ad intervals;
at most one ad is assigned to each interval; and
S contains at most one ad from each advertiser (i.e., each advertiser has at most one ad displayed). This feature of allowing only one ad per advertiser is optional and, in other instances, an advertiser can submit several ads. (The algorithms of the subject invention easily allow several ads to be displayed simultaneously, simply by treating the ads as if they come from different advertisers. Thus, if desired, the algorithms can provide an instance where the number of displayed ads per advertiser can be limited to at most one, provided that the different ads can be identified as belonging to the same advertiser.)

For each ad A, the advertiser has a utility or “value,” represented, for example, as a cost-per-click (CPC(A)), for receiving a click-through on that particular ad. In a feasible solution, each ad A has a click-through rate defined as the probability that ad A receives a click. As examples, several models for estimating these click-through rates can include, but are not limited by:
Model “a”—The click-through rate of an ad A placed in intervals i, i+1, . . . with k competing ads displayed in slots 1 through i−1 is an arbitrary function of A, i, and k.
Model “b”—The same as the previous model, except the click-through rate only depends on A and i.
Model “c”—Each ad A has a normalized click-through-rate (CTR(A)) defined as the probability that ad A receives a click when it is displayed at the top/beginning of the ad interval (e.g., if ad A has length x, then the CTR(A) is the probability of a click on ad A when ad A occupies interval slots 1 through x). The actual click-through-rate of an ad A occupying interval slots i through j with k competing ads displayed in interval slots 1 through i−1 is estimated by CTRᵢⱼₖ(A)=αᵢⱼₖ*CTR(A), where αᵢⱼₖ are scaling factors that do not depend on the ad A. In this model, the expected utility or “value” of ad A is denoted by s(A)=CPC(A)*CTR(A).
Model “d”—The same as the previous model, except αᵢⱼₖ only depends on k.
Model “e”—The same as Model “c,” except it is assumed that there are scaling factors β₁, . . . β_{L} such that αᵢⱼₖ=(βᵢ+ . . . +βⱼ)/(j−i+1). In other words, αᵢⱼₖ does not depend on k and is equal to the average of the scaling factor for the slots that the ad occupies.

There are other variants of the above models; for example, click-through rate of an ad could depend on the total number of ads displayed in the page. One skilled in the art can appreciate that there are additional variants within the scope of the subject invention as well.

Thus, the expected utility of an advertiser for one impression of an ad A is the click-through rate of the ad times CPC(A). A feasible allocation of maximum expected welfare is then sought. The welfare is computed as the sum of the expected utilities of the displayed ads.

Allocations

Several example algorithms that solve the allocation problem under different assumptions are described as examples employed by instances of the subject invention. When analyzing these algorithms, a parameter n is utilized to denote the total number of ads included in the input to the algorithm. It is important to note that in most cases, the size of n can be assumed to be proportional to L (which is fairly small), rather than to the total number of ads that participate in the auction (which might be very large). This is a consequence of employing a pre-processing stage that removes from the auction all ads that have little or no substantial chance of winning the auction. For example, a model is called monotone if it has the following natural property: for every two ads A and B of equal size, if s(A) (as defined supra) is at least as large as s(B), then in any allocation of intervals for ads that includes ad B but no ad by the bidder who requests ad A, replacing ad B by ad A does not decrease the expected welfare. For monotone models, all ads of length l except for the (L−l+1) ads of highest s value can be safely discarded (breaking ties arbitrarily), as there still remains an optimal allocation without these ads. Hence n need not be larger than L². If there are altogether N ads of size l, then the pre-processing stage of finding the (L−l+1) length−l ads of highest value (and discarding all other ads) can be done in time O(NlogL), by standard sorting-based algorithms.

Allocation Algorithm Examples

Typically, “welfare-maximizing” is in respect to true valuations. However, for the below examples, “welfare-maximizing” is in respect to reported valuations, not necessarily true ones.

Solution 1: Here L is assumed to be a small constant, and an algorithm is described that computes the welfare-maximizing allocation in Model “b” (allowing each advertiser to submit multiple ads). Dynamic programming is utilized to compute a 2^{L}×n table W of real numbers. Each entry of W is indexed by a binary string x of length L and an integer j between 1 and n. The first index, xε{0,1}^{L}, is a string representing available ad interval in the schedule. A one in the i'th coordinate of x indicates that the i'th slot of the ad interval is available for an ad. The value of W(x,j) is the maximum welfare that can be achieved by scheduling ads from advertisers 1, . . . , j in the slots indicated as available by x. Define W(x,0)=0 for all x. The value of W(x,j) is computed recursively as follows: Consider an ad A of advertiser j of length l(A). Let i be a coordinate of x that is at the beginning of a sequence of l(A) consecutive ones. It is desirable to compute the value of scheduling A starting at position i. Let y be a vector equal to x except that coordinates i through i+l(A)−1 are zero. Then the maximum welfare that can be achieved by A starting at position i is W(y,j−1) plus CPC(A)*CTR(A,i), the expected value of A starting in position i. The value of W(x,j) is the maximum of W(x,j−1) and max_{A,i}(W(y,j−1)+CPC(A)*CTR(A,i)) (where the maximum is over A and i, and y is constructed from x as explained above).

Solution 2: Here, L is not assumed to be small, but each advertiser is assumed to submit just one ad. This allows a construction of a dynamic programming solution with table size L×n under certain assumptions. These assumptions permit defining a universal ordering on the set of ads such that the maximum welfare of any feasible subset of the ads is realized by the universal ordering restricted to that subset. More precisely, a universal order for a set of ads Q is an ordering π of the ads in Q such that for every subset S of Q, the ordering of ads in Q according to π maximizes the social welfare. Such an ordering need not exist in every model. However, assuming αₖ's in Model “d” and βₖ's in Model “e” are non-increasing, Models “d” and “e” can be shown to admit universal ordering as follows:
Universal Ordering for Model “d” Theorem—In Model “d,” the universal ordering is given by sorting ads in decreasing order of s(A).
Universal Ordering for Model “e” Theorem—In Model “e,” the universal ordering is given by sorting ads in decreasing order of s(A)/l(A).
   Both of the above theorems can be proved by switching two consecutive ads that do not follow the universal ordering and showing that the resulting ordering achieves a higher (or equal) welfare.

Consider ads in the universal order A₁, . . . , Aₙ, and let W_{i,j} be the maximum achievable welfare using ads A₁ through Aᵢ and exactly j×1 ad interval (W_{i,j} is zero if this is not feasible). Then the maximum achievable welfare overall is max_{j≦L}W_{n,j}. The value of W_{1,j} for all j is clear. The value of W_{i,j} can be computed recursively as follows:
W_{i+1,j}=max(W_{i,j},W_{i,j-l(A}_{ᵢ₊₁}₎α_{abc}s(Aᵢ₊₁)) (Eq. 1)
if l(Aᵢ₊₁)≦j,
W_{i+1,j}=W_{i,j} otherwise. (Eq. 2)
In the above formula, a=j−l(Aᵢ₊₁), b=j, and c is the number of ads scheduled in the solution for W_{i,j-l(A}_{ᵢ₊₁}₎.

Solution 3: When L is not constant, the welfare maximizing problem in Model “b” becomes NP-hard. However, a 2-approximation to the welfare-maximal allocation in polynomial time can be computed as follows. Consider the set of ad placements consisting of all feasible positions of all ads and order the ads in this set in increasing order of the ending position. For ads with the same ending position and same length, order them according to their s value (which can be done at no extra cost, if the pre-processing stage described above was performed). Thus, for example, with an ad A of length 2 and an ad B of length 5 with an ad interval of length 6, the ordering would be (A,1), (A,2), (A,3), (A,4), (B,1), (A,5), (B,2), where pair (x,i) indicates the placement of ad x starting at position i. Let v(x,i) be the value (e.g., the click-thru-rate times the cost-per-click) of scheduling ad x starting at position i. An ad (y,j) conflicts with (x,i) if y was submitted by the same advertiser that submitted x or if the interval occupied by (y,j) overlaps with the interval occupied by (x,i).

This instance of the subject invention's algorithm processes ads in the order defined above. At each step, it takes the current ad placement (x,i) in the ordering and subtracts the value v(x,i) of (x,i) from the value v(y,j) of all ad placements (y,j) that conflict with (x,i) and are after it in the ordering. It then discards any ad placements whose resulting value is negative and continues. Once the algorithm has traversed the entire ordering, it considers ad placements in the reverse order restricted to ad placements with positive value. At each step, it greedily selects the next ad placement (x,i) in the reverse ordering and deletes any ad placement (y,i) that conflicts with (x,i).

This algorithm outputs a 2-approximation to the welfare-maximal solution. Moreover, if all ads happen to be of unit length, the algorithm actually produces an optimal allocation.

Solution 4: In a general setting, the following greedy heuristic can be utilized. For each ad A of length l(A), let CTR′(A)=CTR(A)/l(A). Sort ads in decreasing order of CTR′(•)*CPC(•). Greedily schedule ads in this order subject to the feasibility conditions.

Allocated Advertisement Pricing

One of the most common means of determining pricing is to utilize cost-per-click (CPC) mechanisms. For example, each advertiser is assessed a cost for each click or indication associated with that advertiser's ad. This allows costs to be adjusted based on an advertiser and/or size of the ad that the click/indication is associated with.

For Solution 4, the following pricing scheme can be utilized. The price charged to the i'th scheduled ad Aᵢ is CTR(Aᵢ₊₁)*CPC(Aᵢ₊₁)/CTR(Aᵢ), where Aᵢ₊₁ is the i+1 'st scheduled ad. Although this greedy heuristic may produce a sub-optimal allocation in terms of welfare maximization, it runs in time O(n log n), and, thus, is asymptotically faster than Solution 3.

In cases where there is an algorithm that always computes the welfare-maximizing allocation, such a payment scheme can be obtained utilizing the well-known Vickrey-Clark-Groves (VCG) method. However, when the allocation algorithm is only approximately welfare-maximizing, then the VCG payments do not necessarily produce an incentive compatible mechanism.

In other instances of the subject invention, pricing can be determined by utilizing the product of a bid times a CTR ratio. Thus, for example, a bid of $2.00 with a CTR ratio of 1% would be priced less than a lower bid of $1.00 with a CTR ratio of 25%. This provides pricing that attempts to balance what an advertiser believes the advertisement is worth against the exposure probability of the advertisement. This allows advertisements with high exposure to be priced accordingly but also compensates for the perceived value from the advertiser themselves.

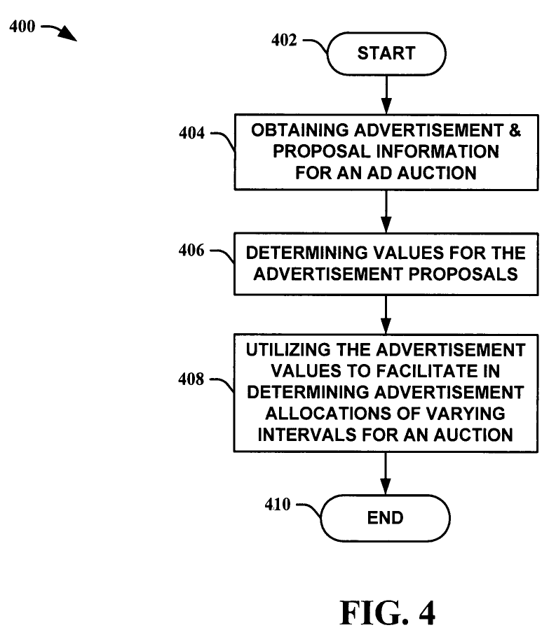

In view of the exemplary systems shown and described above, methodologies that may be implemented in accordance with the subject invention will be better appreciated with reference to the flow charts of FIGS. 4-6. While, for purposes of simplicity of explanation, the methodologies are shown and described as a series of blocks, it is to be understood and appreciated that the subject invention is not limited by the order of the blocks, as some blocks may, in accordance with the subject invention, occur in different orders and/or concurrently with other blocks from that shown and described herein. Moreover, not all illustrated blocks may be required to implement the methodologies in accordance with the subject invention.

The invention may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the subject invention.

In FIG. 4, a flow diagram of a method 400 of facilitating advertisement allocations in accordance with an aspect of the subject invention is shown. The method 400 starts 402 by obtaining advertisement and proposal information for an advertisement auction 404. The advertisement and proposal information can include, for example, a total ad interval and a list of proposed ads and bids and the like. The total ad interval can be comprised of, for example, a number of units of space or time that is to be allocated. This is typically a positive integer p. Each ad can contain information such as, for example, an identifier of an advertiser, a desired interval, a value, and additional side conditions and the like. The interval can be defined by a starting position m and an ending position z such that 1≦m≦z≦p. The value, for example, can include what a bidder is willing to pay and/or what a content provider thinks they can charge and the like. The side conditions can indicate how a value changes depending on, for example, the number of ads that occur before and/or after a particular advertiser's advertisement, starting position m of the ad, and/or ending position z of the ad and the like. For example, Models “a”-“e” supra can be utilized as side conditions. Side condition types can include, but are not limited to, depending only on a proposed ad itself (e.g., changing m and z) and/or depending on other advertisements (e.g., number of advertisements before the proposed advertisement). The values for the advertisement proposals are then determined 406. The value determination can be facilitated with the proposal information described supra and/or additional information and the like associated with a proposed ad. Advertisement allocations of varying intervals for an auction are then determined utilizing the advertisement values 408, ending the flow 410. The allocation determinations can utilize allocation mechanisms and algorithms described supra and the like.

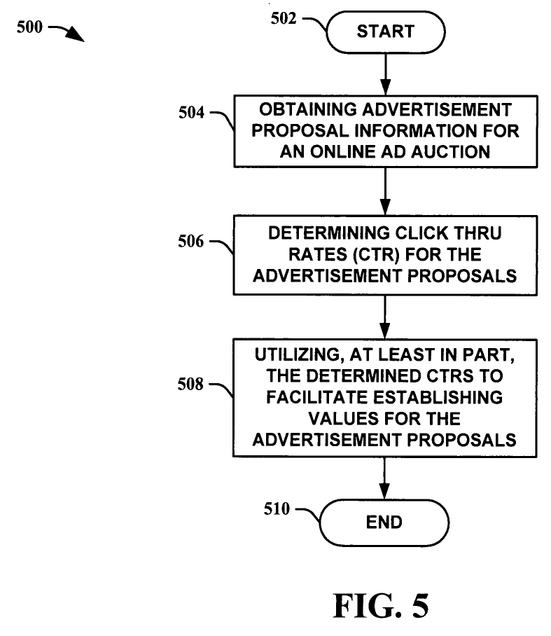

Turning to FIG. 5, a flow diagram of a method 500 of facilitating advertisement proposal value determinations in accordance with an aspect of the subject invention is depicted. The method 500 starts 502 by obtaining advertisement proposal information for an online advertisement auction 504. The advertisement proposal information can include, for example, a proposal list and side conditions as described supra and the like. Click-through-rates are then determined for the advertisement proposals 506. CTR determination methods can include, but are not limited to, processes described in Models “a”-“e” and the like. In general, CTRs are associated with online advertising techniques that indicate traffic associated with a particular proposal. One skilled in the art can appreciate that other instances of the subject invention can utilize other forms of traffic evaluation and fall within the scope of the subject invention. Values for the advertisement proposals are then determined utilizing, at least in part, the CTR information to facilitate the process 508, ending the flow 510. The determined values can be utilized in instances of the subject invention that determine allocations of ads with varying intervals.

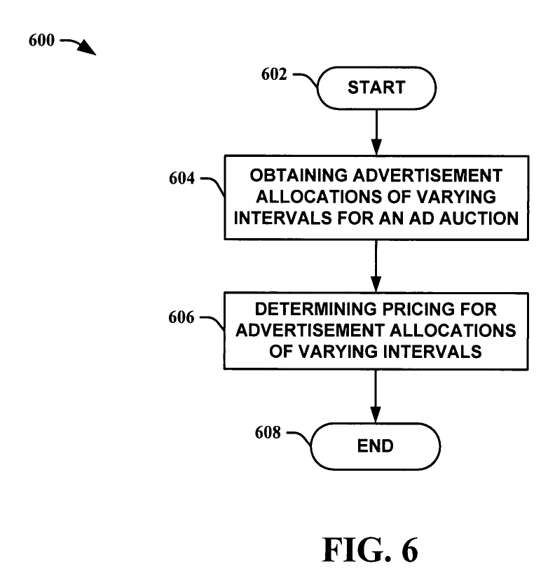

Looking at FIG. 6, a flow diagram of a method 600 of facilitating advertisement allocation pricing in accordance with an aspect of the subject invention is illustrated. The method 600 starts 602 by obtaining advertisement allocations of varying intervals for an advertisement auction 604. Methods utilized to create allocations of varying intervals are described supra. Pricing is then determined for the advertisement allocations of varying intervals 606, ending the flow 608. As noted supra, for each allocation algorithm, payment schemes are evaluated that implement the allocation in an incentive compatible manner. In cases where there is an algorithm that always computes the welfare-maximizing allocation, such a payment scheme can be obtained utilizing, for example, a Vickrey-Clark-Groves (VCG) method. However, when the allocation algorithm is only approximately welfare-maximizing, then the VCG payments do not necessarily produce an incentive compatible mechanism. CTR based pricing schemes can also be utilized by instances of the subject invention as well as those schemes described previously. One skilled in the art can appreciate that other pricing schemes not elaborated upon are also within the scope of the present invention.

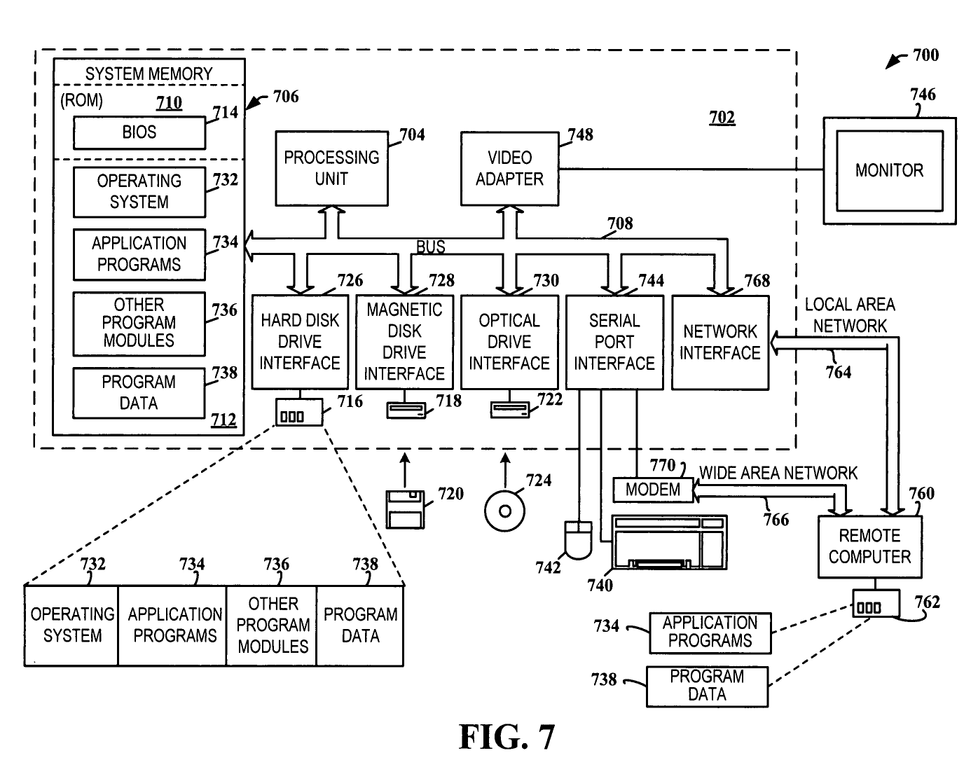

In order to provide additional context for implementing various aspects of the subject invention, FIG. 7 and the following discussion is intended to provide a brief, general description of a suitable computing environment 700 in which the various aspects of the subject invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types. Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

As used in this application, the term “component” is intended to refer to a computer-related entity, either hardware, a combination of hardware and software, software, or software in execution. For example, a component may be, but is not limited to, a process running on a processor, a processor, an object, an executable, a thread of execution, a program, and a computer. By way of illustration, an application running on a server and/or the server can be a component. In addition, a component may include one or more subcomponents.

With reference to FIG. 7, an exemplary system environment 700 for implementing the various aspects of the invention includes a conventional computer 702, including a processing unit 704, a system memory 706, and a system bus 708 that couples various system components, including the system memory, to the processing unit 704. The processing unit 704 may be any commercially available or proprietary processor. In addition, the processing unit may be implemented as multi-processor formed of more than one processor, such as may be connected in parallel.

The system bus 708 may be any of several types of bus structure including a memory bus or memory controller, a peripheral bus, and a local bus using any of a variety of conventional bus architectures such as PCI, VESA, Microchannel, ISA, and EISA, to name a few. The system memory 706 includes read only memory (ROM) 710 and random access memory (RAM) 712. A basic input/output system (BIOS) 714, containing the basic routines that help to transfer information between elements within the computer 702, such as during start-up, is stored in ROM 710.

The computer 702 also may include, for example, a hard disk drive 716, a magnetic disk drive 718, e.g., to read from or write to a removable disk 720, and an optical disk drive 722, e.g., for reading from or writing to a CD-ROM disk 724 or other optical media. The hard disk drive 716, magnetic disk drive 718, and optical disk drive 722 are connected to the system bus 708 by a hard disk drive interface 726, a magnetic disk drive interface 728, and an optical drive interface 730, respectively. The drives 716-722 and their associated computer-readable media provide nonvolatile storage of data, data structures, computer-executable instructions, etc. for the computer 702. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment 700, and further that any such media may contain computer-executable instructions for performing the methods of the subject invention.

A number of program modules may be stored in the drives 716-722 and RAM 712, including an operating system 732, one or more application programs 734, other program modules 736, and program data 738. The operating system 732 may be any suitable operating system or combination of operating systems. By way of example, the application programs 734 and program modules 736 can include an advertisement allocation scheme in accordance with an aspect of the subject invention.

A user can enter commands and information into the computer 702 through one or more user input devices, such as a keyboard 740 and a pointing device (e.g., a mouse 742). Other input devices (not shown) may include a microphone, a joystick, a game pad, a satellite dish, a wireless remote, a scanner, or the like. These and other input devices are often connected to the processing unit 704 through a serial port interface 744 that is coupled to the system bus 708, but may be connected by other interfaces, such as a parallel port, a game port or a universal serial bus (USB). A monitor 746 or other type of display device is also connected to the system bus 708 via an interface, such as a video adapter 748. In addition to the monitor 746, the computer 702 may include other peripheral output devices (not shown), such as speakers, printers, etc.

It is to be appreciated that the computer 702 can operate in a networked environment using logical connections to one or more remote computers 760. The remote computer 760 may be a workstation, a server computer, a router, a peer device or other common network node, and typically includes many or all of the elements described relative to the computer 702, although for purposes of brevity, only a memory storage device 762 is illustrated in FIG. 7. The logical connections depicted in FIG. 7 can include a local area network (LAN) 764 and a wide area network (WAN) 766. Such networking environments are commonplace in offices, enterprise-wide computer networks, intranets and the Internet.

When used in a LAN networking environment, for example, the computer 702 is connected to the local network 764 through a network interface or adapter 768. When used in a WAN networking environment, the computer 702 typically includes a modem (e.g., telephone, DSL, cable, etc.) 770, or is connected to a communications server on the LAN, or has other means for establishing communications over the WAN 766, such as the Internet. The modem 770, which can be internal or external relative to the computer 702, is connected to the system bus 708 via the serial port interface 744. In a networked environment, program modules (including application programs 734) and/or program data 738 can be stored in the remote memory storage device 762. It will be appreciated that the network connections shown are exemplary and other means (e.g., wired or wireless) of establishing a communications link between the computers 702 and 760 can be used when carrying out an aspect of the subject invention.

In accordance with the practices of persons skilled in the art of computer programming, the subject invention has been described with reference to acts and symbolic representations of operations that are performed by a computer, such as the computer 702 or remote computer 760, unless otherwise indicated. Such acts and operations are sometimes referred to as being computer-executed. It will be appreciated that the acts and symbolically represented operations include the manipulation by the processing unit 704 of electrical signals representing data bits which causes a resulting transformation or reduction of the electrical signal representation, and the maintenance of data bits at memory locations in the memory system (including the system memory 706, hard drive 716, floppy disks 720, CD-ROM 724, and remote memory 762) to thereby reconfigure or otherwise alter the computer system's operation, as well as other processing of signals. The memory locations where such data bits are maintained are physical locations that have particular electrical, magnetic, or optical properties corresponding to the data bits.

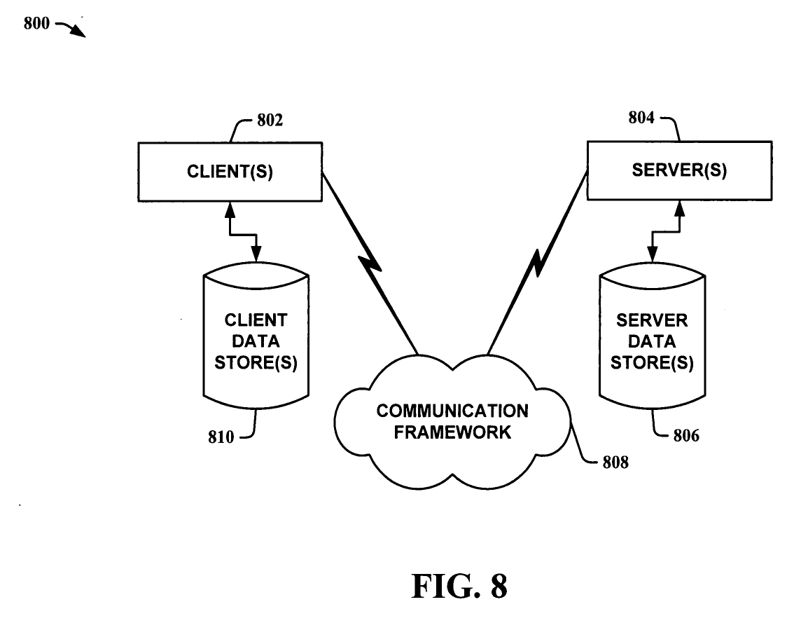

FIG. 8 is another block diagram of a sample computing environment 800 with which the subject invention can interact. The system 800 further illustrates a system that includes one or more client(s) 802. The client(s) 802 can be hardware and/or software (e.g., threads, processes, computing devices). The system 800 also includes one or more server(s) 804. The server(s) 804 can also be hardware and/or software (e.g., threads, processes, computing devices). One possible communication between a client 802 and a server 804 may be in the form of a data packet adapted to be transmitted between two or more computer processes. The system 800 includes a communication framework 808 that can be employed to facilitate communications between the client(s) 802 and the server(s) 804. The client(s) 802 are connected to one or more client data store(s) 810 that can be employed to store information local to the client(s) 802. Similarly, the server(s) 804 are connected to one or more server data store(s) 806 that can be employed to store information local to the server(s) 804.

It is to be appreciated that the systems and/or methods of the subject invention can be utilized in advertisement allocation facilitating computer components and non-computer related components alike. Further, those skilled in the art will recognize that the systems and/or methods of the subject invention are employable in a vast array of electronic related technologies, including, but not limited to, computers, servers and/or handheld electronic devices, and the like.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates advertisement interval allocations for auctions, comprising:
a value component that receives information relating to advertisement proposals and determines values for the proposals; and
an allocation component that employs an allocation mechanism to determine advertisement allocations of varying intervals utilizing the proposal values.

2. The system of claim 1, the intervals comprising time and/or physical dimensions.

3. The system of claim 1, the allocation component utilizes an allocation mechanism that assumes an overall interval to be a small constant and determines a welfare-maximizing allocation where advertisers are allowed to submit multiple advertisements.

4. The system of claim 1, the allocation component utilizes an allocation mechanism that assumes that each advertiser submits only one advertisement and determines a welfare-maximizing allocation via a universal ordering on a set of advertisements where the maximum welfare of a feasible subset of the advertisements is realized by the universal ordering restricted to that subset.

5. The system of claim 1, the allocation component utilizes an allocation mechanism that employs a 2-approximation to determine a welfare-maximal allocation in polynomial time.

6. The system of claim 1, the allocation component utilizes an allocation mechanism that employs a greedy heuristic to determine a welfare-maximal allocation.

7. The system of claim 1, the value component utilizes, in part, click-through-rates (CTR) to facilitate in determining the proposal values.

8. The system of claim 7 further comprising:
a click-through-rate (CTR) determination component that determines a click-through-rate utilized by the value component; the click through rate indicating the probability that the advertisement receives a click.

9. The system of claim 8, the CTR determination component employs a model where an ad A placed in intervals i, i+1, . . . with k competing ads displayed in slots 1 through i−1 is an arbitrary function of A, i, and k.

10. The system of claim 8, the CTR determination component employs a model where an ad A placed in intervals i, i+1, . . . with k competing ads displayed in slots 1 through i−1 is an arbitrary function of A and i.

11. The system of claim 8, the CTR determination component employs a model where each ad A has a normalized click-through-rate and an actual click-through-rate of an ad A occupying interval slots i through j with k competing ads displayed in interval slots 1 through i−1 and is estimated by CTRᵢⱼₖ(A)=αᵢⱼₖ*CTR(A), where αᵢⱼₖ are scaling factors independent of the ad A, CTR(A) is the probability that ad A receives a click when it is displayed at the top and/or beginning of an ad interval, and a value of ad A is denoted by s(A)=CPC(A)*CTR(A).

12. The system of claim 8, the CTR determination component employs a model where each ad A has a normalized click-through-rate and an actual click-through-rate of an ad A occupying interval slots i through j with k competing ads displayed in interval slots 1 through i−1 and is estimated by CTRᵢⱼₖ(A)=αᵢⱼₖ*CTR(A), where αᵢⱼₖ are scaling factors that depend only on k, CTR(A) is the probability that ad A receives a click when it is displayed at the top and/or beginning of an ad interval, and a value of ad A is denoted by s(A)=CPC(A)*CTR(A).

13. The system of claim 8, the CTR determination component employs a model where each ad A has a normalized click-through-rate and an actual click-through-rate of an ad A occupying interval slots i through j with k competing ads displayed in interval slots 1 through i−1 and is estimated by CTRᵢⱼₖ(A)=αᵢⱼₖ*CTR(A), where αᵢⱼₖ=(βᵢ+ . . . βⱼ)/(j−i+1) and β₁, . . . , β_{L} are scaling factors and αᵢⱼₖ is independent of k and equal to an average of a scaling factor for interval slots that an ad occupies, CTR(A) is the probability that ad A receives a click when it is displayed at the top and/or beginning of an ad interval, and a value of ad A is denoted by s(A)=CPC(A)*CTR(A).

14. The system of claim 8, the click-through-rate is dependent on a total number of advertisements allotted in a total advertisement interval.

15. The system of claim 1 further comprising:
a pricing component that facilitates in determining pricing for the advertisement allocations determined by the allocation component.

16. The system of claim 15, the pricing component utilizes, at least in part, a Vickrey-Clark-Groves (VCG) method to facilitate in determining pricing for the advertisement allocations.

17. A method for facilitating advertisement interval allocations for auctions, comprising:
receiving information relating to advertisement proposals;
determining values for the advertisement proposals; and
determining advertisement allocations of varying intervals utilizing the proposal values.

18. The method of claim 17 further comprising:
utilizing a click-through-rate to facilitate in determining the values for the proposals; the click-through-rate indicating a probability that a proposed advertisement receives a click.

19. The method of claim 17, the intervals comprising time and/or physical dimensions.

20. The method of claim 17 further comprising:
determining pricing for the advertisement allocations utilizing, at least in part, a Vickrey-Clark-Groves (VCG) method.
